(19) United States
(12) Patent Application Publication
(10) Pub. No.: US 2012/0328250 A1
(43) Pub. Date: Dec. 27, 2012

(54) DIRECT-INCIDENCE OPTICAL-ELECTRICAL CONNECTION DEVICE

(75) Inventor: Haven Yang, New Taipei City (TW)

(73) Assignee: ALL BEST PRECISION TECHNOLOGY CO., LTD., Taoyuan County (TW)

(21) Appl. No.: 13/169,607

(22) Filed: Jun. 27, 2011

(51) Int. Cl. G02B 6/43

(52) U.S. Cl. 385/89

(57) ABSTRACT

A direct-incidence optical-electrical connection device for coupling to optical fibers and thereby converting an optical signal in the optical fibers into an electrical signal includes a substrate, an optical connection unit, a communication unit, and an electrical connection unit. The optical connection unit, the communication unit, and the electrical connection unit are disposed on the substrate. The optical connection unit connects the optical fibers. The communication unit is vertically disposed at an end of an edge of the optical connection unit. The ends of the optical fibers correspond directly to the communication unit for admitting the optical signal. Then, by optical-electrical conversion (OEC), the optical signal is converted into an electrical signal to be sent to the electrical connection unit. Then, the electrical signal from the electrical connection unit is converted into an optical signal to be sent to the optical connection unit via the communication unit.

### FIELD OF THE INVENTION

The present invention relates to optical-electrical connection devices, and more particularly, to a direct-incidence optical-electrical connection device directly coupled to optical fibers for performing optical-electrical conversion and optical-electrical connection.

### BACKGROUND OF THE INVENTION

A conventional optical-electrical connector enables an optical fiber to be coupled to an electronic circuit, such that an optical signal is converted into an electrical signal by an optical-electrical conversion unit disposed in the optical-electrical connector, thereby not only allowing a back-end electronic circuit to perform a subsequent electrical signal processing process, but also converting the electrical signal into the optical signal by means of an electrical-optical conversion unit to thereby effectuate electrical-optical communication and optical-electrical communication.

However, as shown in FIG. 1, an optical-electrical connector 2 is coupled to an optical fiber 4, and an optical signal LS being transmitted within the optical fiber 4 undergoes secondary optical conversion (by a beam splitter, for example). The secondary optical conversion requires a slanted surface 6 of the optical-electrical connector 2 and involves changing an optical signal path. Nonetheless, persons skilled in the art should understand that the optical signal LS that undergoes secondary optical conversion inevitably incurs optical loss resulting from reflection, diffraction, and diffusion; as a result, the optical signal LS is likely to go wrong at a light-receiving end 8, thus resulting in an increase in the bit error rate (BER). Also, since the secondary optical conversion requires the slanted surface 6 of the optical-electrical connector 2, there is difficulty in aligning the optical signal LS of the optical fiber 4 with the light-receiving end 8.

Accordingly, it is imperative for the present invention to provide a direct-incidence optical-electrical connection device for overcoming the aforesaid drawbacks of the prior art.

### SUMMARY OF THE INVENTION

It is an objective of the present invention to provide a direct-incidence optical-electrical connection device for allowing, after coupling the direct-incidence optical-electrical connection device to optical fibers, an optical signal and an electrical signal to undergo optical-electrical conversion and optical-electrical connection directly without going through secondary optical conversion (such as reflection, refraction, diffraction, and diffusion) so as to cut costs, streamline a manufacturing process, and reduce wear and tear.

In order to achieve the above and other objectives, the present invention provides a direct-incidence optical-electrical connection device for coupling to a plurality of optical fibers and thereby converting an optical signal in the optical fibers into an electrical signal, the direct-incidence optical-electrical connection device comprising: a substrate; an optical connection unit disposed on the substrate and connected to the optical fibers; a communication unit having an optical detector and an optical transmitter, the communication unit being disposed on the substrate and at an end of an edge of the optical connection unit for performing optical-electrical conversion; and an electrical connection unit connected to the communication unit for receiving the electrical signal converted from the optical signal by the communication unit sending the electrical signal, in a form of the optical signal, to the optical connection unit via the communication unit.

In an embodiment of the present invention, the optical detector of the direct-incidence optical-electrical connection device of the present invention is a photoconductor, a p-n photodiode, a p-i-n photodiode, an avalanche photodiode, or a heterojunction photodiode.

In an embodiment of the present invention, the optical detector and the optical transmitter of the direct-incidence optical-electrical connection device of the present invention are positioned at the same horizontal level as the optical connection unit does.

In an embodiment of the present invention, the optical detector and the optical transmitter form n×m configuration states of optical input/output, where n and m denote integers.

In an embodiment of the present invention, the optical connection unit has a plurality of grooves for receiving the optical fibers, respectively.

In an embodiment of the present invention, the grooves are V-shaped and thus the optical fibers are received at the bottoms of the V-shaped grooves, respectively.

In an embodiment of the present invention, the optical connection unit is an enterprise system connector, a ferrule connector, a fiber distributed data interface connector, a local connector, a subscriber connector, a straight tip connector, or a multi-fiber push on connector.

In an embodiment of the present invention, the optical connection unit is an angled physical contact-style connector.

Compared with the prior art, the present invention provides a direct-incidence optical-electrical connection device that comprises an optical connection unit directly coupled to optical fibers. An optical signal being transmitted within the optical fibers is directly sent to a communication unit and thus incurs little coupling loss (arising from diffraction or diffusion, for example), so as to effectuate conversion between an optical signal and an electrical signal, efficient optical-electrical coupling, and enable the subsequent processing of the optical signal and the electrical signal.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a schematic view of the structure of an optical-electrical connection device;

FIG. 2 is a schematic view of the structure of a direct-incidence optical-electrical connection device according to an embodiment of the present invention;

FIG. 3 is a cross-sectional view of the direct-incidence optical-electrical connection device taken along line A-A′ of FIG. 2; and

FIG. 4 is a cross-sectional view of grooves of the direct-incidence optical-electrical connection device taken along line B-B′ of FIG. 2.

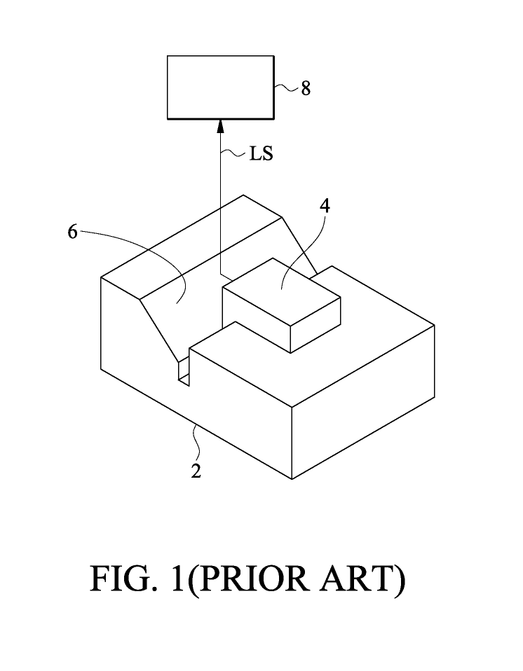

### DETAILED DESCRIPTION OF THE PREFERRED EMBODIMENTS

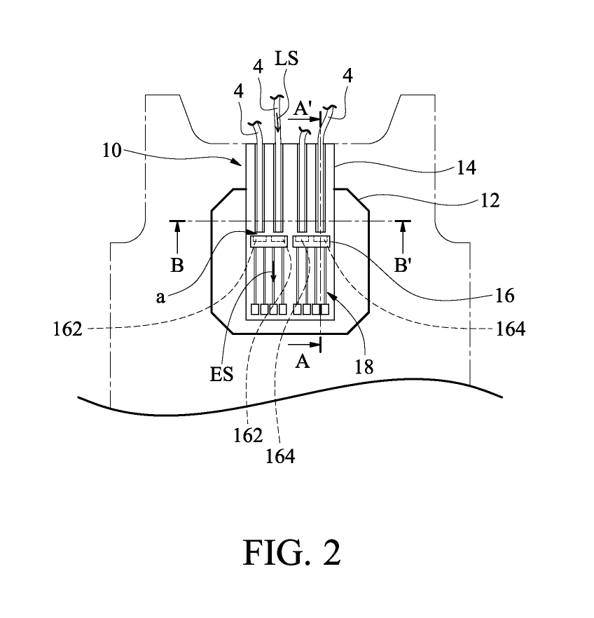

Referring to FIG. 2, there is shown a schematic view of the structure of a direct-incidence optical-electrical connection device according to an embodiment of the present invention. As shown in FIG. 2, the direct-incidence optical-electrical connection device 10 is coupled to a plurality of optical fibers 4 to convert an optical signal LS in the optical fibers 4 into an electrical signal ES. The optical fibers 4 are single-mode fibers or multi-mode fibers.

The direct-incidence optical-electrical connection device 10 comprises a substrate 12, an optical connection unit 14, a communication unit 16, and an electrical connection unit 18. The substrate 12 underpins the optical connection unit 14, the communication unit 16, and the electrical connection unit 18. For example, the substrate 12 is a semiconductor substrate or a printed circuit substrate.

The optical connection unit 14 is disposed on the substrate 12. The optical connection unit 14 is connected to the optical fibers 4. The optical connection unit 14 is an enterprise system connector, a ferrule connector, a fiber distributed data interface connector, a local connector, a subscriber connector, a straight tip connector, or a multi-fiber push on connector. Optionally, to prevent reflection, the optical connection unit 14 is an angled physical contact-type connector.

An embodiment of the present invention is exemplified by the optical connection unit 14 having a plurality of grooves 142. The optical fibers 4 are directly received in the grooves 142 of the optical connection unit 14, respectively. The grooves 142 not only allow the optical fibers 4 to be firmly disposed on the substrate 12 but also enable the optical fibers 4 to be efficiently aligned with the communication unit 16. Hence, the communication unit 16 lies at the same horizontal level as the optical connection unit 14 does, so as to reduce the optical loss arising from incoming radiation and outgoing radiation. The shape of the grooves 142 is subject to changes as needed. In an embodiment of the present invention, the grooves 142 are V-shaped, and thus the optical fibers 4 are received at the bottoms of the V-shaped grooves 142, respectively, as shown in FIG. 4. In this regard, FIG. 4 is a cross-sectional view of the grooves 142 of the direct-incidence optical-electrical connection device 10 taken along line B-B′ of FIG. 2. In this embodiment, the grooves 142 are exemplified by four grooves. In this embodiment, two of four said grooves 142 function as channels for inputting the optical signal LS, and the other two of four said grooves 142 function as channels for outputting the optical signal LS.

The communication unit 16 comprises an optical detector 162 and an optical transmitter 164. The communication unit 16 is disposed on the substrate 12 and at the end a of an edge of the optical connection unit 14. In this regard, the communication unit 16 is vertically disposed on the substrate 12, such that the optical detector 162 and the optical transmitter 164 can directly receive the optical signal LS from the optical fibers 4. Hence, the optical signal LS can directly enter the optical detector 162 without optical conversion (such as reflection, refraction, diffraction, and diffusion) which is otherwise carried out by a secondary optical element (such as a lens or a beam splitter), and the electrical signal ES is converted into the optical signal LS by means of the communication unit 16, thereby allowing the optical signal LS to be sent by the communication unit 16 to the optical fibers 4 disposed on the optical connection unit 14.

Furthermore, optical-electrical conversion (OEC) or electrical-optical conversion (EOC) takes place at the communication unit 16. The optical detector 162 is a photoconductor, a p-n photodiode, a p-i-n photodiode, an avalanche photodiode, or a hetero junction photodiode. The optical transmitter 164 is a light emitting diode or a laser diode.

Furthermore, the optical detector 162 and the optical transmitter 164 form n×m configuration states of optical input/output, where n and m denote integers. In this regard, both the optical detector 162 and the optical transmitter 164 correspond in quantity to the optical fibers 4. In another embodiment, the optical detector 162 and the optical transmitter 164 are arranged precisely enough to enable the optical signals LS of different wavelengths to reach different positions of the optical detector 162. In an embodiment of the present invention, the quantity of the optical detectors 162 and the optical transmitters 164 are not restrictive of the quantity of the channels. In yet another embodiment, when transmitted by dense wavelength-division multiplexing (DWDM), the optical signal LS is applicable to multi-channel high-capacity data transmission performed at different wavelengths.

The electrical connection unit 18 is connected to the communication unit 16. The electrical connection unit 18 receives the electrical signal ES converted from the optical signal LS by the communication unit 16, and sends the electrical signal ES, in the form of the optical signal LS, to the optical fibers 4 of the optical connection unit 14 via the communication unit 16. In an embodiment, the electrical connection unit 18 is connected via a gold-finger electrical connection end thereof to a back-end electronic circuit, such that the electrical signal ES can be processed by the electronic circuit. After being processed by the electronic circuit, the electrical signal ES can be further sent to the communication unit 16 by the electrical connection unit 18, such that the electrical signal ES can be converted into the optical signal LS, and then the optical signal LS is sent out of the direct-incidence optical-electrical connection device 10 for finalizing the couple-transmission of the optical-electrical signal.

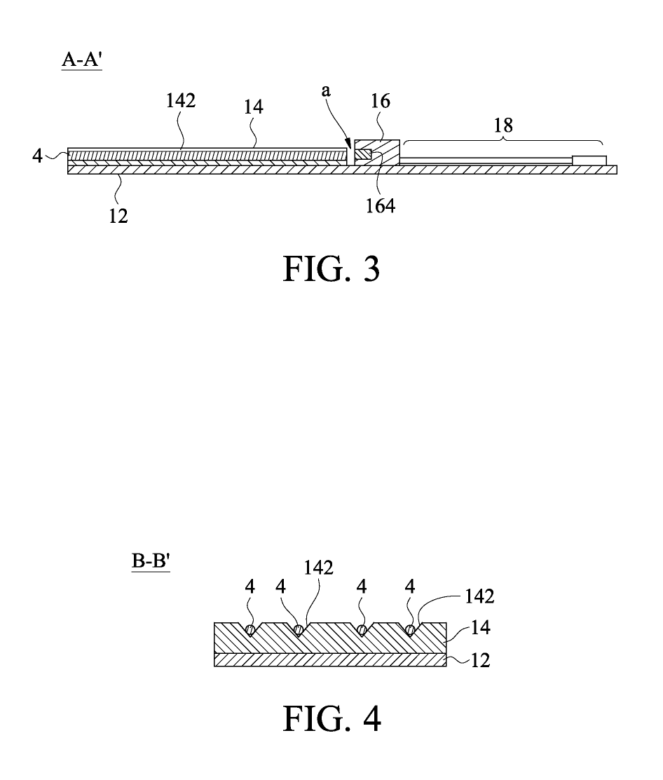

Referring to FIG. 3, there is shown a cross-sectional view of the direct-incidence optical-electrical connection device 10 taken along line A-A′ of FIG. 2. As shown in FIG. 3, the communication unit 16 is vertically disposed on the substrate 12, both the optical detector 162 and the optical transmitter 164 of the communication unit 16 are directly and accurately aligned with the optical fibers 4 through the optical connection unit 14, thereby dispensing with the need to convert the optical signal LS (originating in the optical fibers 4) by an angle through secondary optical conversion as taught by the prior art.

A direct-incidence optical-electrical connection device of the present invention comprises an optical connection unit directly coupled to optical fibers. An optical signal being transmitted within the optical fibers is directly sent to a communication unit and thus incurs little coupling loss (arising from diffraction or diffusion, for example), so as to effectuate conversion between an optical signal and an electrical signal, efficient optical-electrical coupling, and enable the subsequent processing of the optical signal and the electrical signal.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A direct-incidence optical-electrical connection device for coupling to a plurality of optical fibers and thereby converting an optical signal in the optical fibers into an electrical signal, the direct-incidence optical-electrical connection device comprising:
a substrate;
an optical connection unit disposed on the substrate and connected to the optical fibers;
a communication unit having an optical detector and an optical transmitter, the communication unit being disposed on the substrate and at an end of an edge of the optical connection unit for performing optical-electrical conversion; and
an electrical connection unit connected to the communication unit for receiving the electrical signal converted from the optical signal by the communication unit sending the electrical signal, in a form of the optical signal, to the optical connection unit via the communication unit.

2. The direct-incidence optical-electrical connection device of claim 1, wherein the optical detector is one of a photoconductor, a p-n photodiode, a p-i-n photodiode, an avalanche photodiode, and a heterojunction photodiode.

3. The direct-incidence optical-electrical connection device of claim 2, wherein the optical transmitter is one of a light-emitting diode and a laser diode.

4. The direct-incidence optical-electrical connection device of claim 3, wherein the optical detector and the optical transmitter are positioned at a same horizontal level as the optical connection unit does.

5. The direct-incidence optical-electrical connection device of claim 4, wherein the optical detector and the optical transmitter form n×m configuration states of optical input/output, where n and m denote integers.

6. The direct-incidence optical-electrical connection device of claim 5, wherein the optical connection unit has a plurality of grooves for receiving the optical fibers, respectively.

7. The direct-incidence optical-electrical connection device of claim 6, wherein the grooves are V-shaped and thus the optical fibers are received at bottoms of the V-shaped grooves, respectively.

8. The direct-incidence optical-electrical connection device of claim 5, wherein the optical connection unit is one of an enterprise system connector, a ferrule connector, a fiber distributed data interface connector, a local connector, a subscriber connector, a straight tip connector, and a multi-fiber push on connector.

9. The direct-incidence optical-electrical connection device of claim 8, wherein the optical connection unit is an angled physical contact-style connector.
